(19) United States
(12) Patent Application Publication
(10) Pub. No.: US 2004/0148218 A1
(43) Pub. Date: Jul. 29, 2004

(54) Telephone number based sales predictor method and system

(75) Inventors: Gregory R. Bovee, Great Falls, VA (US); Kenneth G. Culver, Robins, IA (US)

Correspondence Address: Craig A. Summerfield, Brinks Hofer Gilson & Lione, P.O. Box 10395, Chicago, IL, 60610, US

(73) Assignee: APAC Customer Services, Inc.

(21) Appl. No.: 10/353,437

(22) Filed: Jan. 29, 2003

(51) Int. Cl. G06F 17/60

(52) U.S. Cl. 705/10

(57) ABSTRACT

Methods and systems for predicting sales based on historical telephone contact are provided. The telephone billing statements of a telemarketing company or other company include called telephone numbers, the time of the call, the length of the call and other information. Telephone numbers that are more frequently called and telephone numbers associated with longer call times may be more likely to accept solicitation and purchase products or services. The telephone billing statements do not include household or personal information, so are more likely to avoid violation of privacy and identity protection standards. The telephone billing statements also do not provide the original source of the telephone number, such as telephone numbers provided by a retail company for a campaign.

### BACKGROUND

This present invention relates to telemarketing. In particular, telephone numbers most likely to lead to sales, interest or acceptance are identified.

Telemarketing companies place millions of calls a month. The telephone numbers are called for any number of marketing or sales campaigns, such as solicitations for telephone companies, banking or credit card companies, insurance companies and retail establishments. Often, the beneficiary of the campaign, such as the credit card company or retail establishment, provides the telephone numbers used in a campaign. The beneficiary obtains the numbers from customers, such as from customer provided telephone numbers acquired at a time of purchase, or from other sources, such as buying a list of telephone numbers.

A customer providing a telephone number may indicate a likelihood of acceptance of solicitation. Other predictors are gleaned from public records. For example, tax filings, real estate records and other public information indicate family income, size, spending patterns or other information. The information is used to target telemarketing to specific people or households more likely to purchase products or services. However, obtaining these predictors may be difficult and expensive.

### BRIEF SUMMARY

The present invention is defined by the following claims, and nothing in this section should be taken as a limitation on those claims. By way of introduction, the preferred embodiments described below include methods and systems for predicting sales based on historical telephone contact. The telephone billing statements of a telemarketing company or other company include called telephone numbers, the time of the call, the length of the call and other information. Telephone numbers that are more frequently called and telephone numbers associated with longer call times may be more likely to accept solicitation and purchase products or services. The telephone billing statements do not include household or personal information, so are more likely to avoid violation of privacy and identity protection standards. The telephone billing statements also do not provide the original source of the telephone number, such as telephone numbers provided by a retail company for a campaign.

In a first aspect, a method predicts sales based on historical telephone contacts. A phone call record is reviewed. A first predictor of acceptance of sales contact for at least a first telephone number is generated from the phone call record.

In a second aspect, a system for predicting sales based on historical telephone contact is provided. A processor is operable to generate a first predictor of acceptance of sales contact for at least a first telephone number from telephone call records in a database.

In a third aspect, another method predicts sales based on historical telephone contacts. A length of at least one telephone contact for each of a plurality of telephone numbers is identified. The likelihood of acceptance of telephone contact is indicated for each of the plurality of telephone numbers as a function of the respective lengths.

In a fourth aspect, yet another method predicts sales based on historical telephone contacts. A telephone billing statement with a plurality of telephone numbers and free of personal identifiers is obtained. Telephone numbers more likely to accept a telemarketing call are identified from information in the telephone billing statement.

Further aspects and advantages of the invention are discussed below in conjunction with the preferred embodiments.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a block diagram of one embodiment of a system for predicting sales based on telephone call records; and

FIG. 2 is a flow chart diagram of one embodiment of a method for predicting sales based on telephone call records.

### DETAILED DESCRIPTION OF THE DRAWINGS AND PRESENTLY PREFERRED EMBODIMENTS

Predictors indicating the best time of contact and the propensity to accept phone-based telemarketing are generated from telephone billing statements. Telephone billing statements of a telemarketing company include many telephone numbers and other non-personal information for each telephone number. The predictors are generated from the anonymous information in the telephone billing statements.

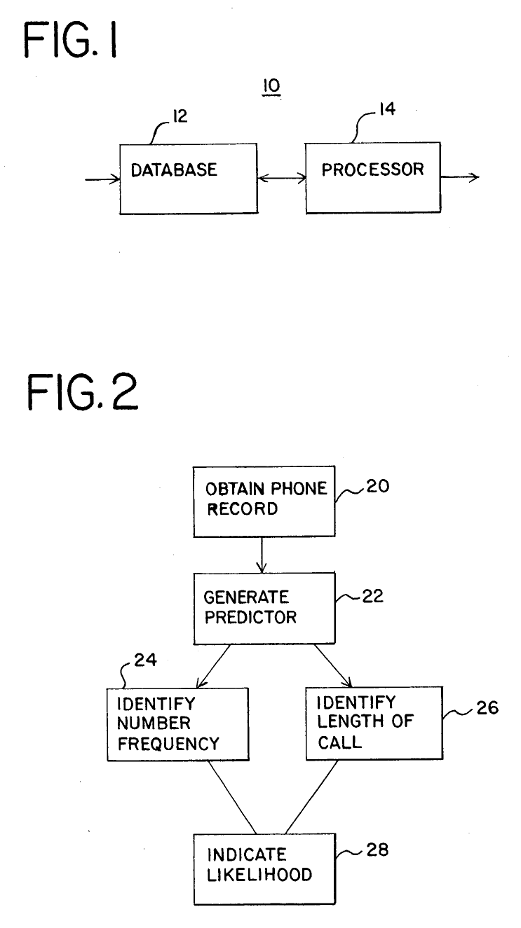

FIG. 1 shows a system 10 for predicting sales likelihood based on previous telephone contact. The system 10 includes a database 12 and a processor 14. In one embodiment, the system 10 is a personal computer, a mainframe computer, a server or other device capable of searching and comparing. Alternatively, the system 10 is an application specific integrated or non-integrated circuit or other dedicated circuit for generating one or more predictors from a telephone call record.

The database 12 comprises a RAM, ROM, portable storage device (e.g. floppy disc, compact disk or memory stick), a server memory or a dedicated database memory. The database 12 stores telephone call records. The telephone call records include a plurality of telephone numbers and at least one other datum of information associated with each or some of the telephone numbers. The other data includes one or more of a time and length of each call for each dial or use of the telephone numbers and whether the call was answered. The telephone call records are free of personal or household identifiers, such as the records being without names, social security numbers, credit card number, drivers license number, address or other personal identifying references. In alternative embodiments, any personal or household identifying information is removed from telephone call records. For a telemarketing company, the telephone call records are free of information identifying the source of the telephone numbers, such as not indicating which customer or campaign is associated with the numbers. The telephone call records include information from any of various time periods. In one embodiment, the telephone call records consist of calls within the last year or 90 days, but other time periods may be used.

In one embodiment, telephone call records are generated by user input of call information. For example, a user places a call and enters data for storage in the database during or after the call. In other embodiments, the telephone call records are telephone billing records of a single telemarketing company or other company. Telephone records for multiple companies may be included. The telephone billing records are provided by one or more different sources, such as from AT&T, MCI, QWEST and/or another telephone service provider. The telephone billing records are copied into the database 12 either by user input or electronic transfer.

The processor 14 comprises a general processor, a dedicated processor, a mainframe computer, an application specific integrated circuit, a digital signal processor, a personal computer or other digital or analog device. The processor 14 electrically connects with the database 12 for searching, comparing, organizing, selecting, calculating or performing other functions with the telephone call records. The processor 14 is operable to generate a predictor of acceptance of sales contact for one or more telephone numbers from the telephone call records. In one embodiment, the processor 14 generates one or more predictors for each or a plurality of telephone numbers in the database.

For example, the processor 14 counts a number of times each telephone number was called during one or more time periods from the phone call record. The more a telephone number was dialed during a time period, the more likely telemarketing calls to the number will be accepted. The predictor for each telephone number is the actual count or a value that is a function of the count.

As another example of generating the predictor, the processor 14 identifies a length of at least one telephone contact for each of the telephone numbers from the telephone call records. The longer a telephone call, the more likely telemarketing calls to the number will be accepted. The predictor for each telephone number is the actual length, an average length of multiple calls for a same telephone number, a numerical ranking or comparative number or a value that is a function of the length. Alternatively, a histogram or groupings of length are identified, such as unanswered and answered calls or call lengths in five minute increments.

As yet another example of generating the predictor, the processor 14 determines an optimal time of contact from the telephone call records. The optimal time of contact is a function of the length of calls to each telephone number as a function of time of day, a frequency or number of answers for each telephone number as a function of time of day, other information and combinations thereof. Any of various divisions of the time of day, day of the week or other time periods may be used based on one or more calculated values. Other predictors may be determined, such as time of contact predictors based on whether a call was answered.

FIG. 2 shows a method for predicting sales likelihood based on previous telephone contact. Additional, different or fewer acts may be used. The method is implemented by the system 10 of FIG. 1 or a different system. Household, account and/or other personal identifying information are frequently provided to a telemarketing company for a telemarketing campaign. Many campaigns for different companies result in large telephone billing records, such as millions of calls dialed in a month. The telephone billing statements are free of the campaign and personal identifying information. The telephone call records may be used to predict future outcomes of telephone contact, the propensity to be contacted for the telephone number, and the propensity to accept telephone solicitation and marketing.

In act 20, the telephone call records are obtained. For example, a telephone billing statement with a plurality of telephone numbers is obtained as an electronic document, such as a spreadsheet, a flat file or in another format. The telephone billing statement is free of personal identifiers. In one embodiment, the telephone billing statement is for a telemarketing company or from a telemarketing campaign. A list of telephone numbers, trunk line, switches, time of dial, length of call, city for the telephone number and/or other information are included in the billing statement. The trunk line, switches and city information may be used for generating regional call lists or groupings of telephone numbers. Telephone call records from other sources, such as a dialer recorded list of calls, are stored, are alternatively or additionally transferred or obtained. Printed or written telephone call records may be used, either by entering them into the database 12 or for manual generation of call predictors.

The telephone call record is reviewed in act 22 to generate one or more predictors. Telephone numbers more likely to accept a telemarketing call are identified from information in the telephone billing statement or call record. The predictors indicate a likelihood of acceptance of telephone contact for one, multiple or each of the plurality of telephone numbers. A predictor is a numerical, alphabetical, symbolic, grouping or other indication of likelihood of acceptance. For example, an numerical value or a relative value is assigned to each telephone number. As another example, telephone numbers more likely to accept calls are placed in a separate grouping or list. One or more than one predictor may be used for each or a sub-set of telephone numbers. In one embodiment, fuzzy logic, a formula, manual assignment or other function is used to combine two or more types of predictors for a same telephone number as a single predictor.

FIG. 2 shows generating two different predictors, such as a different predictor for each telephone number or different predictors for different telephone numbers. Only one or three or more types of predictors may be generated for one or more of the telephone numbers.

In act 24, a number of times each telephone number was called is counted from the phone call record. The number comprises the predictor. Alternatively, the number is used to determine the predictor, such as by applying a threshold to the number to group the telephone numbers into two or more lists or as including the number in a mathematical or fuzzy logic calculation. Households or telephone numbers more likely to engage in or accept telephone solicitation may be more frequently called since the success of one solicitation is likely to result in further solicitations. The number of times each telephone number was called is calculated over one or more time periods, such as over the last one, two or three months. Multiple frequency of contact predictors based on multiple time periods may be used individually or combined, such as a 30 day, 90 day and one year monthly rolling averages.

In act 26, a length of at least one telephone contact for each telephone number is identified from the phone call record. In one embodiment, only connected or answered calls are included in the calculation, but unanswered calls may be included in other embodiments. The telephone talk time associated with a previous solicitation may indicate willingness to consider telephone or other solicitation. The length or average length comprises the predictor. Alternatively, the length or average length is used to determine the predictor, such as by applying a threshold to the number to group the telephone numbers into two or more lists or as including the number in a mathematical or fuzzy logic calculation. Where more than one call was made to a telephone number in the telephone call record, an average, weighted average or other function of length is calculated. The length of calls for each telephone number is calculated over one or more time periods, such as over the last one, two and/or three months. For example, an average length of call is calculated for each of a one, two and three month time periods. Multiple length of call values based on multiple time periods may be used individually or combined.

In other embodiments, acts other than acts 24 and 26 shown in FIG. 2 are used in addition or as an alternative to acts 24 and 26. One example act is generating one or more predictors as an optimal time for contact, such as the time of day or day of the week. The optimal time of contact predictor is a function of information from the telephone call records. For example, the length of calls to each telephone number is determined as a function of the time of contact. Where answered calls are longer in the evening, morning or other time period as compared to other time periods, the optimal time of day is indicated. In one embodiment, the day is divided into four time periods (morning, day, evening and night), but any number of same or different time divisions may be used. As another example, the frequency or number of answers is determined as a function of time of contact. In one embodiment, the time periods comprise days of the week. If more calls are answered on Mondays for a particular telephone number, then the predictor indicates Monday as the optimal time of contact. Other information may be used to identify an optimal time for contact. Any combination of time of day, day of the week or other time periods may be used. The predictor comprises a ranking based on the number of time periods (e.g. a 1 or 4 value indicating an optimal time period out of 4 time periods), a total or average call length for the time of contact period, a total or average number of answers in a time period or other value. More than two optimal time of contact predictors may be generated for a same or different length time periods. Multiple different predictors for each telephone number may be combined using fuzzy logic or mathematically, but separate predictors may also be used.

In act 28, the predictors indicate the likelihood of acceptance of telemarketing or solicitation calls. In one embodiment, the telephone numbers are sorted based on one, multiple or a combination of predictors. Any of various possible sorting routines may be used, such as different sorting routines for different campaigns. The telephone numbers most likely to accept calls are called first or during particular time periods. Telephone numbers less likely to accept calls are called at other time periods, time permitting or not called.

Additionally or alternatively, a threshold is applied to one or more predictors. Predictors indicating a likelihood of call acceptance greater than or equal to the threshold identify telephone number for including in a call list. For example, a sub-set of telephone numbers associated with longer length calls, a larger number of calls or other parameter based on information from the telephone call records are included in a list. Telephone numbers less likely to accept telemarketing or other solicitation are excluded from the list. Different thresholds may be used, such as selecting the 100,000 most likely to accept a call telephone numbers based on one or more predictors. Different campaigns may use different thresholds.

In one embodiment, the predictors for (1) optimal time-of-day/day-of-week for contact and (2) the likelihood-of-purchase predictor based upon talk time are used for separate purposes and not combined into a single index. The optimal time of contact predictor is used to optimize when a telephone number should be called for a best response and the likelihood-of-purchase predictor is used to identify the most likely purchasers for contact. For example, one predictor establishes the telephone numbers to call, and another predictor establishes when to call the selected telephone numbers. The most likely purchasers are culled from an extended list of possible contacts using various threshold values in order to reduce an extended list to a smaller, more focused list. Additionally, telephone numbers associated with more likely purchasing might receive preferential or different contact than other telephone numbers. For example, premium leads might be routed to the best performing telemarketing agents, restricted to weekend contacts, or otherwise serviced in a different manner. In yet other alternative embodiments, multiple predictors are combined using any function, logic or other combination to select and/or organize some telephone numbers in comparison to other telephone numbers.

Telephone numbers may be reassigned to different households. The likelihood of acceptance of telemarketing or other solicitation based on telephone call records may be inaccurate for reassigned telephone numbers. In one embodiment, reassignment is detected based on one or more predictors or other telephone call record information. For example, 30 day or 30 day and 90 day rolling averages of frequency of contact values differing from a one year rolling average indicate a telephone number reassignment. A threshold difference, such as a 50% difference, indicates reassignment from normal variance. As another example, the length of contact predictor or a combination of the length of contact and frequency of contact predictor over different time periods identifies reassignment. Different thresholds, functions, predictors or other information may be used to detect reassignment. New predictors replace previous predictors for a reassigned telephone number. For example, where the difference as a function of time is between 90 days and a year, then telephone records within only the most recent three months or 90 days are used to generate predictors for the telephone number.

In other embodiments, predictors are compared with other predictors or thresholds in any of various functions to identify further information. For example, a pattern of consist optimal time of contact that changes suddenly, such as from optimal evening contact to optimal morning contact, may indicate a new child or baby or a change in employment. Changes in employment or a new baby result in increased acceptance of telemarketing for some campaigns (e.g., baby products, mortgage insurance or credit counseling).

The telemarketing company from which the telephone call records were obtained uses the predictors and associated telephone numbers in campaigns. The telemarketing company provides optimal telephone numbers for solicitation campaigns. The customers of the telemarketing company purchase the predictors and/or list of telephone numbers for use in the campaign or more likely use the telemarketing company due to the predictors. The list and/or predictors may be sold or rented to other companies, such as selling or renting to other telemarketing companies or companies performing their own “in-house” telemarketing campaigns. In another embodiment, predictors are sold or rented without selling a list of telephone numbers. The buyer provides the telephone numbers, and predictors for each of the provided telephone numbers are returned to the buyer once or periodically.

Identity anonymous telephone call records are used to predict and optimize outbound telemarketing. As privacy and identity protections are changed or increased, identity anonymous information more likely satisfies any new legislative standards and societal standards. The telephone billing records transform from an accounting or payment device to a marketing tool for telemarketing.

While the invention has been described above by reference to various embodiments, it should be understood that many changes and modifications can be made without departing from the scope of the invention. For example, a telemarketing company or a non-telemarketing company predicts the acceptance of solicitation telephone calls or personal contact from telephone call records for a company other than a telemarketing company. As another example, personal identification information may be provided as part of or later added to the telephone call records.

It is therefore intended that the foregoing detailed description be regarded as illustrative rather than limiting, and that it be understood that it is the following claims, including all equivalents, that are intended to define the spirit and scope of this invention.

I (we) claim:

1. A method for predicting sales likelihood based on previous telephone contact, the method comprising:
(a) reviewing a phone call record; and
(b) generating a first predictor of acceptance of sales contact for at least a first telephone number from the phone call record.

2. The method of claim 1 wherein (b) comprises counting a number of times the first telephone number was called from the phone call record.

3. The method of claim 1 wherein (a) comprises reviewing the phone billing record of a telemarketing company.

4. The method of claim 1 wherein (a) comprises reviewing the phone billing records from a telemarketing campaign.

5. The method of claim 1 wherein (b) comprises identifying a length of at least one telephone contact for the first telephone number from the phone call record.

6. The method of claim 5 wherein (a) comprises reviewing the phone billing record of a telemarketing company;
further comprising:
(c) counting a number of times the first telephone number was called from the phone billing record; and
(d) generating a second predictor of acceptance of sales contact for at least the first telephone number from the phone billing record.

7. The method of claim 1 wherein (b) comprises generating the first predictor as an optimal time of contact, the optimal time of contact a function of at least one of: the length of calls to the first phone number as a function of time of contact, the frequency of answers as a function of time of contact and combinations thereof.

8. The method of claim 1 wherein (b) comprises generating the first predictor for a plurality of telephone numbers.

9. The method of claim 1 wherein (b) comprises generating the first predictor as an average.

10. The method of claim 9 wherein (b) comprises generating the first predictor as an average length of contact over a first time period; and
further comprising:
(c) generating a second predictor as an average length of contact over a second time period, the second time period longer than the first time period.

11. The method of claim 1 wherein the phone call record comprises a source of information free of personal identifiers.

12. A system for predicting sales likelihood based on previous telephone contact, the system comprising:
a database of telephone call records; and
a processor operable to generate a first predictor of acceptance of sales contact for at least a first telephone number from the telephone call records.

13. The system of claim 12 wherein the processor is operable to count a number of times the first telephone number was called from the phone call record, the first predictor being a function of the number.

14. The system of claim 12 wherein the database comprises a phone billing record of a telemarketing company.

15. The system of claim 12 wherein the processor is operable to identify a length of at least one telephone contact for the first telephone number from the telephone call records, the first predictor being a function of the length.

16. The system of claim 12 wherein the processor is operable to generate the first predictor as an optimal time of contact, the optimal time of contact a function of at least one of: a length of calls to the first phone number as a function of time of contact, a frequency of answers for the first phone number as a function of time of contact and combinations thereof.

17. The system of claim 12 wherein the processor is operable to generate the first predictor for each of a plurality of telephone numbers in the database.

18. The system of claim 12 further comprises a record in the database of the first predictor for each of a plurality of telephone numbers, the record free of personal identifiers.

19. A method for predicting sales likelihood based on previous telephone contact, the method comprising:
(a) identifying a length of at least one telephone contact for each of a plurality of telephone numbers; and
(b) indicating a likelihood of acceptance of telephone contact for each of the plurality of telephone numbers as a function of respective lengths.

20. The method of claim 19 wherein (a) comprises identifying an average length of multiple telephone contacts for each of the plurality of telephone numbers and (b) comprises indicating the likelihood as a function of the respective averages.

21. The method of claim 19 wherein the indication of (b) is free of personal identifiers.

22. The method of claim 19 wherein (b) comprises generating a list of telephone numbers with a parameter responsive to the length above a threshold.

23. A method for predicting sales likelihood based on previous telephone contact, the method comprising:
(a) obtaining a telephone billing statement with a plurality of telephone numbers and free of personal identifiers; and
(b) identifying telephone numbers more likely to accept a telemarketing call from information in the telephone billing statement.

24. The method of claim 23 wherein (b) comprises:
(b1) identifying a length of calls for each of the plurality of telephone numbers; and
(b2) selecting a sub-set of telephone numbers associated with longer length calls from the plurality of telephone numbers.

25. The method of claim 23 wherein (b) comprises:
(b1) identifying a number of calls during a time period for each of the plurality of telephone numbers; and
(b2) selecting a sub-set of telephone numbers associated with a larger number of calls from the plurality of telephone numbers.

26. The method of claim 23 further comprising:
(c) identifying a time for a call to be more likely accepted for each telephone number from the information in the telephone billing statement.
